(19) United States
(12) Patent Application Publication
(10) Pub. No.: US 2008/0232770 A1
(43) Pub. Date: Sep. 25, 2008

(54) METHOD FOR ACTIVATING VIDEO-AUDIO DATA IN AN OPTICAL DISC AND RELATED SYSTEM

(76) Inventors: Hung-Te Chou, Taipei County (TW); Chun-Ming Su, Taipei County (TW); Hung-Te Lin, Taipei (TW); Yung-Chao Tseng, Taipei County (TW); Chih-Chung Chang, Taipei City (TW); Kuang-Che Wu, Taipei County (TW); Meng-Jyi Shieh, Taipei County (TW); Kuo-Hsin Yang, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/773,942

(22) Filed: Jul. 5, 2007

(30) Foreign Application Priority Data
Mar. 19, 2007 (TW) 096109390

(51) Int. Cl. H04N 5/91

(52) U.S. Cl. 386/94; 386/E05.068

(57) ABSTRACT

A method for activating video-audio data in an optical disc includes determining whether a first activation signal is received or not, a program in the optical disc allowing access to partially-featured contents of the video-audio data when the first activation signal is not received, and the program in the optical disc allowing access to fully-featured contents of the video-audio data when the first activation signal is received.

### BACKGROUND OF THE INVENTION

1. Field of the Invention

The present invention relates to a method for activating video-audio data in an optical disc and related system, and more particularly, to a method and related system for allowing access to partially-featured contents or fully-featured contents of the video-audio data in the optical disc according to activation signals.

2. Description of the Prior Art

With developments of technology, huge data needing to be stored is becoming more and more common. Hence, data storage technology progresses unceasingly. Optical discs have gradually replaced traditional storage media such as magnetic discs, music tapes, or videotapes and are generally applied to store huge data including audio or video data by its virtue of small volume, high storage capacity, and reliable data stability. Some of the common optical disc formats today include compact discs (CD), digital versatile discs (DVD), and blue-ray discs (BD).

Under certain conditions, copyright owners of published optical discs will lock partial video-audio data in the optical disc. Only partially-featured contents but not fully-featured contents of the video-audio data can be accessed when users buy the optical disc with a basic price. Comparing with the fully-featured contents of the video-audio data, the partially-featured contents of the video-audio data have limitations in data capacity, display quality, and effective display time. Assuming that the video-audio data stored in the optical disc totally includes five video albums, at this time, the partially-featured contents of the video-audio data only include the 1st video album and the fully-featured contents of the video-audio data include the five video albums. Assuming that the video-audio data stored in the optical disc is a show introducing famous paintings, at this time, the partially-featured contents of the video-audio data is a data played by a lower display quality and the fully-featured contents of the video-audio data is a data played by a higher display quality. Assuming that the video-audio data stored in the optical disc is a music video show, at this time, the partially-featured contents of the video-audio data is a data allowing users to watch the music video show within a predetermined period and the fully-featured contents of the video-audio data is a data allowing the users to watch the music video show permanently.

The users need to pay extra fees to the copyright owners of the published optical disc for getting authorizations for accessing the fully-featured contents of the video-audio data if the users desire to watch the fully-featured contents of the video-audio data after accessing the partially-featured contents of the video-audio data. Hence, the optical discs can provide an activation mechanism to effectively control the accesses to the partially-featured contents or the fully-featured contents of the video-audio data.

### SUMMARY OF THE INVENTION

The present invention provides a method for activating video-audio data in an optical disc. The method includes determining whether a first activation signal is received or not, a program in the optical disc allowing access to a first featured content of the video-audio data if the first activation signal is not received, and the program in the optical disc allowing access to a second featured content of the video-audio data if the first activation signal is received.

The present invention provides a system for providing video-audio data activation mechanism. The system includes a judging device, a driving device, and a playing device. The judging device is used for determining whether a first activation signal is received or not. The driving device is used for allowing access to a first featured content of the video-audio data if the first activation signal is not received and used for allowing access to a second featured content of the video-audio data if the first activation signal is received. The playing device is used for playing the first featured content and the second featured content of the video-audio data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow diagram illustrating a method for activating video-audio data in an optical disc according to a first embodiment of the present invention.

FIG. 2 is a flow diagram illustrating a method for activating video-audio data in an optical disc according to a second embodiment of the present invention.

FIG. 3 is a flow diagram illustrating a method for activating video-audio data in an optical disc according to a third embodiment of the present invention.

FIG. 4 is a flow diagram illustrating a method for activating video-audio data in an optical disc according to a fourth embodiment of the present invention.

FIG. 5 is a flow diagram illustrating a method for activating video-audio data in an optical disc according to a fifth embodiment of the present invention.

FIG. 6 is a flow diagram illustrating a method for activating video-audio data in an optical disc according to a sixth embodiment of the present invention.

### DETAILED DESCRIPTION

The present invention controls the access to video-audio data in an optical disc through a program in the optical disc. The program in the optical disc allows access to partially-featured contents or a first featured content of the video-audio data if an activation signal cannot be received and allows access to fully-featured contents or a second featured content of the video-audio data if the activation signal can be received. As mentioned above, the partially-featured contents of the video-audio data have more limitations, such as in data capacity, display quality, and effective display time, than the fully-featured contents of the video-audio data.

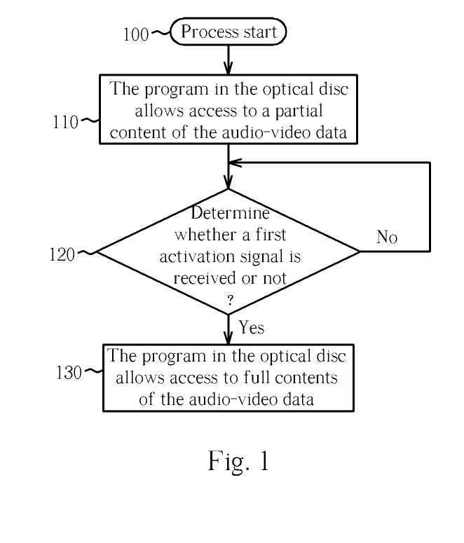

Please refer to FIG. 1, a flow diagram illustrating a method for activating video-audio data in an optical disc according to a first embodiment of the present invention. The flow diagram includes the following steps:

Step 100: Process start.

Step 110: The program in the optical disc allows access to a partial content of the video-audio data.

Step 120: Determine whether a first activation signal can be received or not. If the first activation signal can be received, the process goes to step 130; otherwise, the process goes back to step 120.

Step 130: The program in the optical disc allows access to full contents of the video-audio data.

In the first embodiment of the present invention, the video-audio data stored in the optical disc totally includes a plurality of TV episodes and the publisher of the optical disc will charge the users according to the number of available TV episodes. However, due to not all the users desiring to watch all the TV episodes, the users' purchasing urges will be lowered if the publisher opens access to all the TV episodes and charge the users higher. For this reason, the publisher can open the access to partial contents of the video-audio data in the optical disc and charge the users lower.

In step 110 of the first embodiment, only access to a partial content of the video-audio data is allowed after the users bought the optical disc. For example, the users can only watch the episode 1 or the previous episodes. If the users desire to watch the following episodes after watching the episode 1 or the previous episodes, the users can connect to a related information platform (such as a secure network for paying on-line) supplied by the publisher and pay extra for watching other episodes through an on-line payment mechanism such as credit card, Pay Pal or other mechanism. The publisher will send out the first activation signal through the information platform after receiving the payment. The first activation signal can be an identification code and the users can input the identification code into the optical disc player. Thus, the program in the optical disc will confirm that the identification code is received in step 120 and allow access to the full contents of the video-audio data in step 130. Or an optical disc player having network functionalities can directly receive the first activation signal through a wireless information platform, and then the program in the optical disc will confirm that the identification code is received in step 120 and allow access to the full contents of the video-audio data in step 130. Hence, the users can decide whether to pay extra for watching the full contents (the fully-featured content) of the video-audio data after watching the partial content (the partially-featured content) of the video-audio data. If the program in the optical disc cannot receive the first activation signal in step 120, the users can re-confirm whether the first activation signal is received and stop accessing or can repeat step 110 of allowing access to the partial content of the video-audio data.

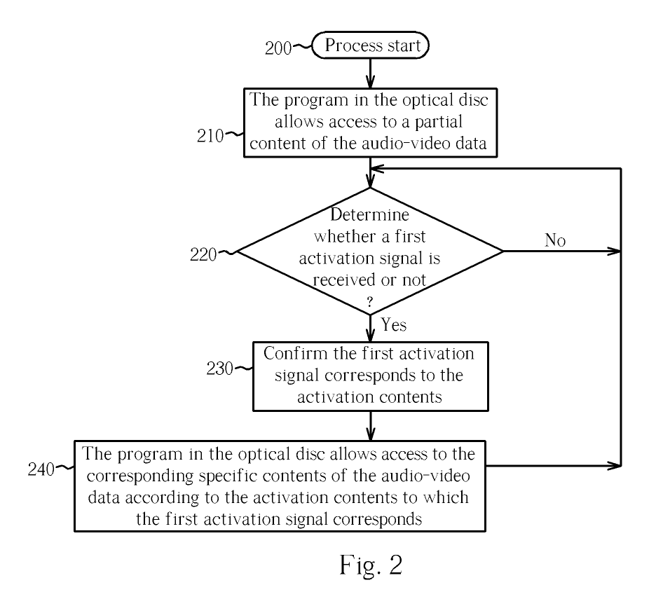

Please refer to FIG. 2, a flow diagram illustrating a method for activating video-audio data in an optical disc according to a second embodiment of the present invention. The flow diagram includes the following steps:

Step 200: Process start.

Step 210: The program in the optical disc allows access to a partial content of the video-audio data.

Step 220: Determine whether a first activation signal is received or not. If the first activation signal is received, the process goes to step 230; otherwise, the process goes back to step 220.

Step 230: Confirm the activation contents to which the first activation signal corresponds.

Step 240: The program in the optical disc allows access to the corresponding specific contents of the video-audio data according to the activation contents to which the first activation signal corresponds, and the process goes back to step 220.

In the second embodiment of the present invention, the video-audio data stored in the optical disc totally includes a plurality of TV episodes and the publisher of the optical disc will charge the users according to the number of the TV episodes. The second embodiment is similar to the first one. The first embodiment of the present invention allows access to the full contents of the video-audio data in step 130 after the first activation signal is received in step 120, but the second embodiment of the present invention further executes step 230 for confirming that the activation contents correspond to the first activation signal. In other words, the corresponding first activation signal is required if the users desire to watch other specific contents (such as other TV episodes) of the video-audio data except the partial content (such as the episode 1) of the video-audio data allowed access in step 210.

For example, if the users desire to watch a designated episode (such as the last episode for watching the ending) after watching the episode 1, the users can connect to the related information platform supplied by the publisher and pay extra for watching the designated episode through an on-line payment mechanism such as credit card, Pay Pal or other mechanism without paying extra for watching the other TV episodes. The publisher will send out the corresponding first activation signal through the information platform after receiving the payment for the designated episode. The first activation signal can be an identification code and the users can input the identification code into the optical disc player. Thus, the program in the optical disc will confirm that the first activation signal is received in step 220, confirm that the first activation signal corresponds to the last episode in step 230, and allow access to the designated content of the last episode of the video-audio data in step 240. Or an optical disc player having network functionalities can directly receive the first activation signal through a wireless information platform, and then the program in the optical disc will confirm that the first activation signal is received in step 220, confirm that the first activation signal corresponds to the last video album in the step 230, and allow access to the designated content of the last episode of the video-audio data in step 240. Hence, the users can flexibly select whether to pay extra for watching other designed contents (the second partially-featured content) of the video-audio data after watching the partial content (the first partially-featured content) of the video-audio data.

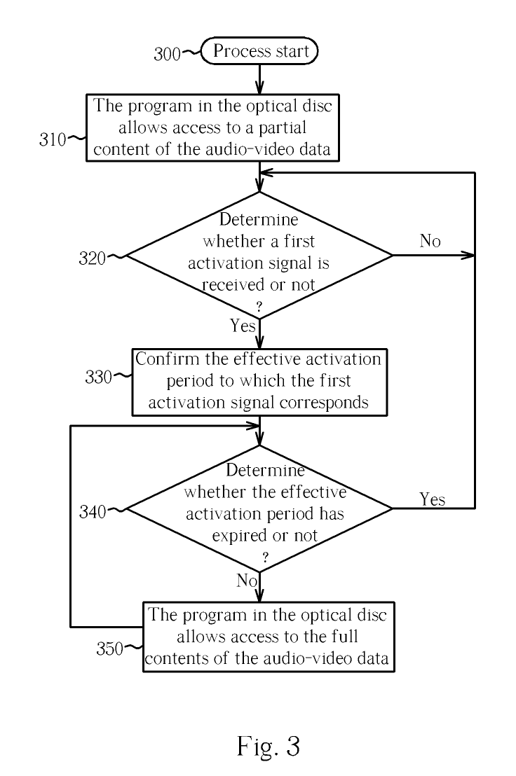

Please refer to FIG. 3, which includes the following steps:

Step 300: Process start.

Step 310: The program in the optical disc allows access to a partial content of the video-audio data.

Step 320: Determine whether a first activation signal is received or not. If the first activation signal is received, the process goes to step 330; otherwise, the process goes back to step 320.

Step 330: Confirm the effective activation period to which the first activation signal corresponds.

Step 340: Determine whether the effective activation period has expired or not. If the effective activation period has not expired yet, the process goes to step 350; otherwise, the process goes back to step 320.

Step 350: The program in the optical disc allows access to the full contents of the video-audio data, and the process goes back to the step 340.

In the third embodiment, the video-audio data stored in the optical disc totally includes a plurality of TV episodes and the publisher will charge the users according to the number of the TV episodes. The third embodiment is similar to the first one. The first embodiment allows access to the full contents of the video-audio data in step 130 after the first activation signal is received in step 120, but the third embodiment further executes step 330 for confirming the effective activation period to which the first activation signal corresponds. In other words, the first embodiment allows access to the full contents of the video-audio data permanently, but the third embodiment only allows access to the full contents of the video-audio data within the effective activation period when under the same condition of receiving the first activation signal. The users can decide whether to watch the full contents of the video-audio data and the needed effective activation period.

For example, if the users judge that the full contents of the video-audio data can be watched within a short period, the users can connect to the related information platform supplied by the publisher and pay extra for a shorter effective activation period (such as the effective activation period for one week) through an on-line payment mechanism such as credit card, Pay Pal or other mechanism. If the users think that the full contents of the video-audio data can be watched repeatedly or shared with others, the users can pay extra for a longer effective activation period (such as the effective activation period for one year). The publisher will send out the corresponding first activation signal through the information platform after receiving the information and the payment for the effective activation period. The first activation signal can be an identification code and the users can input the identification code into the optical disc player. Thus, the program in the optical disc will confirm that the first activation signal is received in step 320, confirm the effective activation period to which the first activation signal corresponds in step 330, and allow access to the full contents of the video-audio data within the effective activation period in steps 340 and 350. Or an optical disc player having network functionalities can directly receive the first activation signal through a wireless information platform, and then the program in the optical disc will confirm that the first activation signal is received in step 320, confirm that the first activation signal corresponds to the effective activation period in step 330, and allow access to the full contents of the video-audio data within the effective activation period in steps 340 and 350. Hence, the users can decide whether to pay extra for watching the full contents (the second partially-featured content) of the video-audio data or for the needed effective activation period according to their preference after watching the partial content (the first partially-featured content) of the video-audio data. A flexible activation mechanism can be provided for the users.

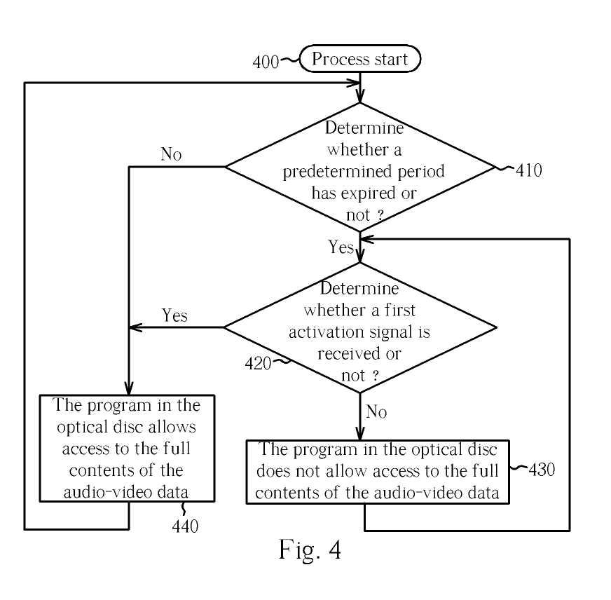

Please refer to FIG. 4, which includes the following steps:

Step 400: Process start.

Step 410: Determine whether a predetermined period has expired. If the predetermined period has not expired yet, the process goes to step 440; otherwise, the process goes to step 420.

Step 420: Determine whether a first activation signal is received or not. If the first activation signal is received, the process goes to step 440; otherwise, the process goes to step 430.

Step 430: The program in the optical disc does not allow access to the full contents of the video-audio data, and process goes back to step 420.

Step 440: The program in the optical disc allows access to the full contents of the video-audio data, and the process goes back to step 410.

In the fourth embodiment, the same example of TV episodes has been provided. The fourth embodiment is similar to the first one. The first embodiment allows access to the full contents of the video-audio data in step 130 after the first activation signal is received in step 120, but the fourth one further executes steps 410 and 420 for determining whether the predetermined period has expired and for determining whether the first activation signal is received. If the predetermined period has not expired or if the predetermined period has expired but the first activation signal can be received, step 440 will be executed to allow access to the full contents of the video-audio data. If the predetermined period has expired and the first activation signal is received, the step 430 will be executed to forbid accessing the full contents of the video-audio data. In other words, the first embodiment allows access to the partial content of the video-audio data before receiving the first activation signal and allows access to the full contents of the video-audio data after receiving the first activation signal, but the fourth embodiment only allows access to the full contents of the video-audio data within the predetermined period or allows access to the full contents of the video-audio data when receiving the first activation signal if the predetermined period has expired.

If the users decide to watch the full contents of the video-audio data outside of the predetermined period, the users can connect to the related information platform supplied by the publisher and pay extra through an on-line payment mechanism such as credit card, Pay Pal or other mechanism. The publisher will send out the corresponding first activation signal through the information platform after receiving the payment. The first activation signal can be an identification code and the users can input the identification code into the optical disc player. Thus, the program in the optical disc will confirm that the identification code is received in step 420, and keep allowing access to the full contents of the video-audio data in step 440. Or an optical disc player having network functionalities can directly receive the first activation signal through a wireless information platform, and then the program in the optical disc will confirm that the identification code is received in step 420, and keep allowing access to the full contents of the video-audio data in step 440. Similarly, if the users decide not to watch the full contents of the video-audio data outside the predetermined period, at this time, the program in the optical disc will execute step 430 to forbid accessing the full contents of the video-audio data. Hence, the users can decide whether to pay extra for watching the full contents (the fully-featured content) of the video-audio data permanently according to their preference after the predetermined period finished (the partially-featured content).

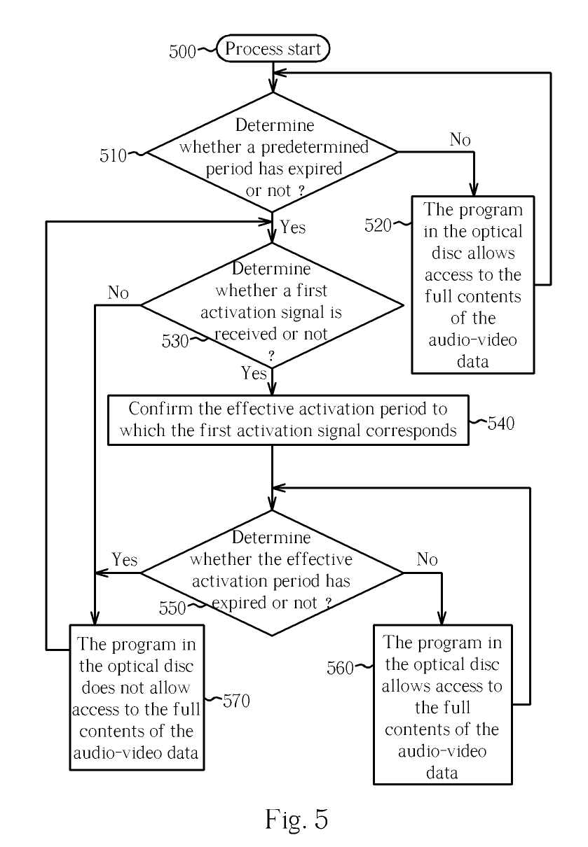

Please refer to FIG. 5, which includes the following steps:

Step 500: Process start.

Step 510: Determine whether a predetermined period has expired or not. If the predetermined period has not expired yet, the process goes to step 520; otherwise, the process goes to step 530.

Step 520: The program in the optical disc allows access to the full contents of the video-audio data, and process goes back to step 510.

Step 530: Determine whether a first activation signal is received or not. If the first activation signal is received, the process goes to step 540; otherwise, the process goes back to step 570.

Step 540: Confirm the effective activation period to which the first activation signal corresponds.

Step 550: Determine whether the effective activation period has expired or not. If the effective activation period has expired, the process goes to step 570; otherwise, the process goes to step 560.

Step 560: The program in the optical disc allows access to the full contents of the video-audio data, and the process goes back to step 550.

Step 570: The program in the optical disc does not allow access to the full contents of the video-audio data, and the process goes back to step 520.

In the fifth embodiment, the video-audio data stored in the optical disc totally includes a plurality of TV episodes and the publisher will charge the users according to the effective activation period. Comparing with the fourth embodiment, the fifth embodiment of further executes step 540 for confirming the effective activation period to which the first activation signal corresponds after determining that the first activation signal is received in the step 530. Hence, the users can flexibly decide the length of the effective activation period (the second partially-featured content) according to their requirements if the users decide to keep watching the full contents of the video-audio data after the predetermined period (the first partially-featured content) expires. Hence, the fifth embodiment can provide a much more flexible activation mechanism to users.

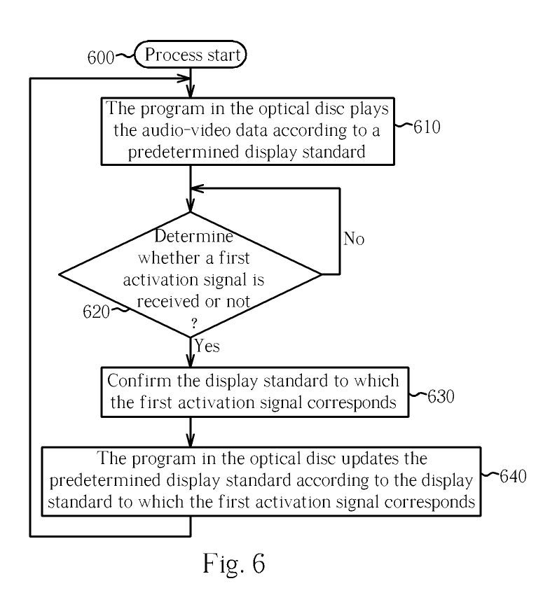

Please refer to FIG. 6, which includes the following steps:

Step 600: Process start.

Step 610: The program in the optical disc plays the video-audio data according to a predetermined display standard.

Step 620: Determine whether a first activation signal is received or not. If the first activation signal is received, the process goes to step 630; otherwise, the process goes back to step 620.

Step 630: Confirm the display standard to which the first activation signal corresponds.

Step 640: The program in the optical disc updates the predetermined display standard according to the display standard to which the first activation signal corresponds, and the process goes back to step 610.

In the sixth embodiment, the publisher of the optical disc will charge the users according to the display standards. However, due to not all the users requiring the highest display standard, the users' purchasing urges will be lowered if the publisher set the video-audio data in the optical disc at the highest display standard and charge the users higher. For this reason, the publisher can set the video-audio data in the optical disc at the lower predetermined display standard and charge the users lower.

In step 610 of the sixth embodiment, the video-audio data can only be played according to a predetermined display standard after the users bought the optical disc. If the users desire to play the video-audio data according to a higher display standard after playing the video-audio data according to the predetermined display standard, the users can connect to a related information platform supplied by the publisher and pay extra for the higher display standard through an on-line payment mechanism such as credit card, Pay Pal or other mechanism. The publisher will send out the first activation signal through the information platform after receiving the payment. The first activation signal can be an identification code and the users can input the identification code into the optical disc player. Thus, the program in the optical disc will confirm that the identification code is received in step 620, confirm the display standard to which the first activation signal corresponds in step 630, and update the predetermined display standard according to the display standard to which the first activation signal corresponds in step 640. At this time, the users can play the video-audio data according to the display standard they desired. Or an optical disc player having network functionalities can directly receive the first activation signal through a wireless information platform, and then the program in the optical disc will confirm that the identification code is received in step 620, confirm the display standard to which the first activation signal corresponds in step 630, and update the predetermined display standard in step 640. Hence, the users can decide whether to pay extra for playing the video-audio data according to a higher display standard (the second partially-featured content) after playing the video-audio data according to a lower display standard (the first partially-featured content). In this embodiment, playing the video-audio data according to the higher display standard includes playing the video-audio data according to the display standards such as higher resolution, superior luminance, superior contrast, or superior tone quality.

In the present invention, the program in the optical disc can only allow access to the contents of the video-audio data having high limitations if the first activation signal is not received, and can allow access to the contents of the video-audio data having low limitations or the full contents of the video-audio data if the first activation signal is received. Hence, the present invention can provide a flexible activation mechanism to users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for activating video-audio data in an optical disc, the method comprising:
determining whether a first activation signal is received or not;
a program in the optical disc allowing access to a first featured content of the video-audio data when the first activation signal is not received; and
the program in the optical disc allowing access to a second featured content of the video-audio data when the first activation signal is received.

2. The method of claim 1, wherein:
the program in the optical disc allowing access to the first featured content of the video-audio data comprises allowing access to partial contents of the video-audio data; and
the program in the optical disc allowing access to the second featured content of the video-audio data comprises allowing access to full contents of the video-audio data.

3. The method of claim 1, wherein:
the program in the optical disc allowing access to the first featured content of the video-audio data comprises allowing access to a first partially-featured content of the video-audio data; and
the program in the optical disc allowing access to the second featured content of the video-audio data comprises allowing access to a second partially-featured content of the video-audio data.

4. The method of claim 1, wherein:
the program in the optical disc allowing access to the first featured content of the video-audio data comprises allowing access to a first partially-featured content of the video-audio data; and
the program in the optical disc allowing access to the second featured content of the video-audio data comprises allowing access to a second partially-featured content of the video-audio data within a predetermined period.

5. The method of claim 4 further comprising confirming the first activation signal corresponds to the predetermined period.

6. The method of claim 4 further comprising determining whether the predetermined period has expired or not.

7. The method of claim 1, wherein:
the program in the optical disc allowing access to the first featured content of the video-audio data comprises allowing access to full contents of the video-audio data within a first predetermined period; and
the program in the optical disc allowing access to the second featured content of the video-audio data comprises allowing access to the full contents of the video-audio data within a second predetermined period.

8. The method of claim 7 further comprising confirming the first activation signal corresponds to the second predetermined period.

9. The method of claim 7 further comprising determining whether the first predetermined period and the second predetermined period have expired or not.

10. The method of claim 1, wherein:
the program in the optical disc allowing access to the first featured content of the video-audio data comprises allowing playing full contents of the video-audio data according to a first display standard; and
the program in the optical disc allowing access to the second featured content of the video-audio data comprises allowing playing the full contents of the video-audio data according to a second display standard.

11. The method of claim 10 further comprising confirming the first activation signal corresponds to the second display standard.

12. The method of claim 10, wherein the second display standard is higher than the first display standard.

13. The method of claim 1, wherein the first activation signal is inputted by a user.

14. The method of claim 1 further comprising:
determining whether a plurality of activation signals including the first activation signal is received or not; and
the program in the optical disc allowing access to a third featured content of the video-audio data when a second activation signal of the plurality of activation signals is received.

15. The method of claim 14, wherein:
the program in the optical disc allowing access to the first featured content of the video-audio data comprises allowing access to a first partially-featured content of the video-audio data;
the program in the optical disc allowing access to the second featured content of the video-audio data comprises allowing access to a second partially-featured content of the video-audio data; and
the program in the optical disc allowing access to the third featured content of the video-audio data comprises allowing access to a third partially-featured content of the video-audio data.

16. The method of claim 14, wherein:
the program in the optical disc allowing access to the third featured content of the video-audio data comprises allowing access to a third partially-featured content of the video-audio data within a predetermined period.

17. The method of claim 16 further comprising confirming the second activation signal corresponds to the predetermined period.

18. The method of claim 14, wherein:
the program in the optical disc allowing access to the first featured content of the video-audio data comprises allowing access to full contents of the video-audio data within a first predetermined period;
the program in the optical disc allowing access to the second featured content of the video-audio data comprises allowing access to the full contents of the video-audio data within a second predetermined period; and
the program in the optical disc allowing access to the third featured content of the video-audio data comprises allowing access to the full contents of the video-audio data within a third predetermined period.

19. The method of claim 18, wherein the third predetermined period is longer than the second predetermined period.

20. The method of claim 18 further comprising:
confirming the first activation signal corresponds to the second predetermined period; and
confirming the second activation signal corresponds to the third predetermined period.

21. The method of claim 14, wherein:
the program in the optical disc allowing access to the first featured content of the video-audio data comprises allowing access to full contents of the video-audio data according to a first display standard;
the program in the optical disc allowing access to the second featured content of the video-audio data comprises allowing access to the full contents of the video-audio data according to a second display standard; and
the program in the optical disc allowing access to the third featured content of the video-audio data comprises allowing access to the full contents of the video-audio data according to a third display standard.

22. The method of claim 21, wherein both the second display standard and the third display standard are higher than the first display standard.

23. The method of claim 21 further comprising:
confirming the first activation signal corresponds to the second display standard; and
confirming the second activation signal corresponds to the third display standard.

24. The method of claim 14, wherein the second activation signal is inputted by a user.

25. A system for providing video-audio data activation mechanism comprising:
a judging device used for determining whether a first activation signal is received or not;
a driving device used for allowing access to a first featured content of the video-audio data when the first activation signal is not received and used for allowing access to a second featured content of the video-audio data when the first activation signal is received; and
a playing device used for playing the first featured content and the second featured content of the video-audio data.
